(19) United States
(12) Patent Application Publication
(10) Pub. No.: US 2024/0121821 A1
(43) Pub. Date: Apr. 11, 2024

(54) METHOD AND APPARATUS FOR HANDLING LBT FOR SIDELINK COMMUNICATION

(71) Applicant: Samsung Electronics Co., Ltd., Suwon-si (KR)

(72) Inventors: Anil AGIWAL, Allen, TX (US); Hyunjeong KANG, Suwon-si (KR)

(21) Appl. No.: 18/476,126

(22) Filed: Sep. 27, 2023

(30) Foreign Application Priority Data
Sep. 29, 2022 (KR) 10-2022-0124659

(51) Int. Cl. H04W 74/08

(52) U.S. Cl. CPC H04W 74/0808; H04W 92/18

(57) ABSTRACT

The disclosure relates to a 5th generation (5G) or 6th generation (6G) communication system for supporting a higher data transmission rate. A method performed by a user equipment (UE) in a wireless communication system is provided. The method includes receiving, from a base station, configuration information associated with a sidelink (SL) listen-before-talk (LBT) failure recovery, identifying a counter value associated with the SL LBT failure detection, based on an SL LBT failure indication received from a lower layer, and in a case where the counter value is greater than or equal to a threshold value, triggering the SL consistent LBT failure.

### CROSS-REFERENCE TO RELATED APPLICATION

This application is based on and claims priority under 35 U.S.C. § 119(a) of a Korean Patent Application No. 10-2022-0124659, filed on Sep. 29, 2022, in the Korean Intellectual Property Office, the disclosure of which is incorporated by reference herein in its entirety.

### BACKGROUND

### 1. Field

The present disclosure relates to wireless communication systems, and more particularly, the disclosure relates to a method and an apparatus for handling a listen-before-talk (LBT) failure in a wireless communication system.

### 2. Description of Related Art

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6th generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio user equipment (NR UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices, which have been exponentially increasing, will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the present disclosure. No determination has been made, and no assertion is made, as to whether any of the above might be applicable as prior art with regard to the disclosure.

### SUMMARY

Aspects of the present disclosure address at least the above-mentioned problems and/or disadvantages and provide at least the advantages described below. Accordingly, an aspect of the disclosure provides both methods and apparatuses for effectively providing a service in a wireless communication system.

Additional aspects will be set forth in part in the description which follows and, in part, will be apparent from the description, or may be learned by practice of the presented embodiments.

In accordance with an aspect of the present disclosure, a method performed by a user equipment (UE) in a wireless communication system is provided. The method includes: receiving, from a base station, configuration information associated with a sidelink (SL) listen-before-talk (LBT) failure recovery; identifying a counter value associated with an SL LBT failure detection, based on an SL LBT failure indication received from a lower layer; and in a case where the counter value is greater than or equal to a threshold value, triggering an SL consistent LBT failure.

In accordance with another aspect of the present disclosure, a user equipment (UE) in a wireless communication system is provided. The UE includes: a transceiver; and at least one processor coupled to the transceiver and configured to: receive, from a base station via the transceiver, configuration information associated with a sidelink (SL) listen-before-talk (LBT) failure recovery; identify a counter value associated with an SL LBT failure detection, based on an SL LBT failure indication received from a lower layer; and in a case where the counter value is greater than or equal to a threshold value, trigger an SL consistent LBT failure.

Other aspects, advantages, and salient features of the present disclosure will become apparent to those skilled in the art from the following detailed description, which, taken in conjunction with the annexed drawings, discloses various embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an architecture of a sidelink communication system according to an embodiment of the present disclosure;

FIG. 2 illustrates a flow chart describing a method performed by a user equipment (UE) according to an embodiment of the present disclosure;

FIG. 3 illustrates a diagram of a UE 300 according to an embodiment of the present disclosure; and

FIG. 4 illustrates a diagram of a base station 400 according to an embodiment of the present disclosure.

Throughout the drawings, it should be noted that like reference numbers are used to depict the same or similar elements, features, and structures.

### DETAILED DESCRIPTION

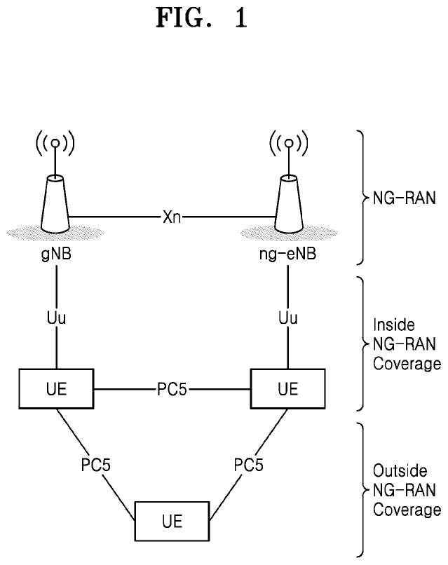

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Throughout the present disclosure, the expression “at least one of a, b or c” indicates only a, only b, only c, both a and b, both a and c, both b and c, all of a, b, and c, or variations thereof. Throughout the specification, a layer (or a layer apparatus) may also be referred to as an entity. Hereinafter, operation principles of the disclosure will be described in detail with reference to accompanying drawings. In the following descriptions, well-known functions or configurations are not described in detail because they would obscure the disclosure with unnecessary details. The terms used in the specification are defined in consideration of functions used in the disclosure, and can be changed according to the intent or commonly used methods of users or operators. Accordingly, definitions of the terms are understood based on the entire descriptions of the present specification.

For the same reasons, in the drawings, some elements may be exaggerated, omitted, or roughly illustrated. Also, a size of each element does not exactly correspond to an actual size of each element. In each drawing, elements that are the same or are in correspondence are rendered the same reference numeral.

Advantages and features of the present disclosure and methods of accomplishing the same may be understood more readily by reference to the following detailed descriptions of embodiments and accompanying drawings of the disclosure. The disclosure may, however, be embodied in many different forms and should not be construed as being limited to the embodiments set forth herein; rather, these embodiments of the disclosure are provided so that this disclosure will be thorough and complete, and will fully convey the concept of the disclosure to one of ordinary skill in the art. Therefore, the scope of the present disclosure is defined by the appended claims. Throughout the specification, like reference numerals refer to like elements. It will be understood that blocks in flowcharts or combinations of the flowcharts may be performed by computer program instructions. Because these computer program instructions may be loaded into a processor of a general-purpose computer, a special-purpose computer, or another programmable data processing apparatus, the instructions, which are performed by a processor of a computer or another programmable data processing apparatus, create units for performing functions described in the flowchart block(s).

The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufactured items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It is also noted that, in some alternative implementations, functions mentioned in blocks may occur out of order. For example, two consecutive blocks may also be executed simultaneously or in reverse order depending on functions corresponding thereto.

As used herein, the term “unit” denotes a software element or a hardware element such as a field-programmable gate array (FPGA) or an application-specific integrated circuit (ASIC), and performs a certain function. However, the term “unit” is not limited to software or hardware. The “unit” may be formed so as to be in an addressable storage medium, or may be formed so as to operate one or more processors. Thus, for example, the term “unit” may include elements (e.g., software elements, object-oriented software elements, class elements, and task elements), processes, functions, attributes, procedures, subroutines, segments of program code, drivers, firmware, micro-codes, circuits, data, a database, data structures, tables, arrays, or variables.

Functions provided by the elements and “units” may be combined into the smaller number of elements and “units,” or may be divided into additional elements and “units.” Furthermore, the elements and “units” may be embodied to reproduce one or more central processing units (CPUs) in a device or security multimedia card. Also, in an embodiment of the present disclosure, the “unit” may include at least one processor. In the following descriptions of the disclosure, well-known functions or configurations are not described in detail because they would obscure the disclosure with unnecessary details.

Hereinafter, for convenience of explanation, the present disclosure uses terms and names defined in the 3rd generation partnership project long term evolution (3GPP LTE) standards. However, the disclosure is not limited to the terms and names, and may also be applied to systems following other standards.

In the present disclosure, an evolved node B (eNB) may be interchangeably used with a next-generation node B (gNB) for convenience of explanation. That is, a base station (BS) described by an eNB may represent a gNB. In the following descriptions, the term “base station” refers to an entity for allocating resources to a user equipment (UE) and may be used interchangeably with at least one of a gNode B, an eNode B, a node B, a base station (BS), a radio access unit, a base station controller (BSC), or a node over a network. The term “terminal” may be used interchangeably with a UE, a mobile station (MS), a cellular phone, a smartphone, a computer, or a multimedia system capable of performing communication functions. However, the disclosure is not limited to the aforementioned examples. In particular, the disclosure is applicable to 3GPP new radio (NR) (or 5th generation (5G)) mobile communication standards. In the following description, the term eNB may be interchangeably used with the term gNB for convenience of explanation. That is, a base station explained as an eNB may also indicate a gNB. The term UE may also indicate a mobile phone, NB-IoT devices, sensors, and other wireless communication devices.

The present disclosure relates to a wireless communication system. Specifically, the disclosure relates to an apparatus, a method, and a system for determining listen-before-talk category for sidelink communication on unlicensed carrier.

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6th generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadband, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio user equipment (NR UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices, which have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed radio (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

In the recent years, several broadband wireless technologies have been developed to meet the growing number of broadband subscribers and to provide more and better applications and services. The second-generation wireless communication system has been developed to provide voice services while ensuring the mobility of users. The third-generation wireless communication system supports not only the voice service but also data service. In recent years, the fourth-generation wireless communication system has been developed to provide high-speed data service. However, currently, the fourth-generation wireless communication system suffers from lack of resources to meet the growing demand for high-speed data services. Accordingly, a fifth-generation wireless communication system (also referred as next generation radio or NR) is being developed to meet the growing demand for high-speed data services, which support ultra-reliability and low latency applications.

The fifth-generation wireless communication system supports not only lower frequency bands but also higher frequency (mmWave) bands, e.g., 10 GHz to 100 GHz bands, so as to accomplish higher data rates. To mitigate propagation loss of the radio waves and increase the transmission distance, the beamforming techniques involving a massive multiple-input multiple-output (MIMO), full dimensional MIMO (FD-MIMO), array antenna, and/or an analog beamforming, large scale antenna, are being considered in the design of fifth-generation wireless communication system. In addition, the fifth-generation wireless communication system is expected to address different use cases having quite different requirements in terms of data rate, latency, reliability, mobility, etc. However, it is expected that the design of the air-interface of the fifth-generation wireless communication system would be flexible enough to serve UEs having quite different capabilities depending on the use case and market segment in which the UEs cater service to the end customer. A few example use cases the fifth-generation wireless communication system is expected to address is enhanced mobile broadband (eMBB), massive machine type communication (m-MTC), ultra-reliable low latency communication (URLL), etc. The eMBB requirements, such as a tens of Gbps data rate, low latency, high mobility, and the like, address the market segment representing the conventional wireless broadband subscribers needing internet connectivity everywhere, all the time and on the go. The m-MTC requirements, such as very high connection density, infrequent data transmission, very long battery life, low mobility address, and the like, address the market segment representing the internet of things (IoT)/internet of everything (IoE) envisioning connectivity of billions of devices. The URLL requirements, such as very low latency, very high reliability and variable mobility, and the like, address the market segment representing the industrial automation application, vehicle-to-vehicle/vehicle-to-infrastructure communication, which is foreseen as an enabler for autonomous cars.

In the fifth-generation wireless communication system operating in higher frequency (mmWave) bands, the UE and gNB communicate with each other using beamforming. Beamforming techniques are used to mitigate the propagation path losses and to increase the propagation distance for communication at higher frequency bands. Beamforming enhances the transmission and reception performance using a high-gain antenna. Beamforming can be classified into Transmission (TX) beamforming performed at a transmitting end and reception (RX) beamforming performed at a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can make a plurality of transmit beam patterns of different directions. Each of these transmit beam patterns can also be referred to as a transmit (TX) beam. A wireless communication system operating at high frequency uses a plurality of narrow TX beams to transmit signals in a cell, as each narrow TX beam provides coverage to a part of the cell. The narrower the TX beam, the higher the antenna gain is and hence the larger the propagation distance of the signal transmitted using beamforming is. A receiver can also make a plurality of receive (RX) beam patterns of different directions. Each of these receive patterns can also be referred to as a receive (RX) beam.

The fifth-generation wireless communication system (NR), supports standalone mode of operation as well as dual connectivity (DC). In DC a multiple Rx/Tx UE may be configured to utilize resources provided by two different nodes (or NBs) connected via a non-ideal backhaul. One node acts as the master node (MN) and the other as the secondary node (SN). The MN and SN are connected via a network interface and at least the MN is connected to the core network. NR also supports multi-RAT dual connectivity (MR-DC) operation whereby a UE in RRC CONNECTED is configured to utilize radio resources provided by two distinct schedulers, located in two different nodes connected via a non-ideal backhaul and providing either E-UTRA (if the node is an ng-eNB) or NR access (if the node is a gNB). In NR, for a UE in RRC CONNECTED and not configured with CA/DC, there is only one serving cell, comprising the primary cell (Pcell). For a UE in RRC CONNECTED and configured with CA/DC, the term ‘serving cells’ is used to denote the set of cells comprising the special cell(s) (SpCell(s)) and all secondary cells (SCells). In NR, the term master cell group (MCG) refers to a group of serving cells associated with the master node, comprising the PCell and optionally one or more SCells. In NR, the term Secondary Cell Group (SCG) refers to a group of serving cells associated with the secondary node, comprising of the primary SCG cell (PSCell) and optionally one or more SCells. In NR, PCell refers to a serving cell in MCG, operating on the primary frequency, in which the UE either performs the initial connection establishment procedure or initiates the connection re-establishment procedure. In NR, for a UE configured with CA, SCell is a cell providing additional radio resources on top of the SpCell. PSCell refers to a serving cell in SCG in which the UE performs random access when performing a reconfiguration with sync procedure. For dual connectivity operation the term SpCell refers to the PCell of the MCG or the PSCell of the SCG, otherwise the term SpCell refers to the PCell.

In the fifth-generation wireless communication system, a physical downlink control channel (PDCCH) is used to schedule downlink (DL) transmissions on a physical downlink shared channel (PDSCH) and uplink (UL) transmissions on a physical uplink shared channel (PUSCH), where the downlink control information (DCI) on PDCCH includes: downlink assignments containing at least modulation and coding format, resource allocation, and hybrid-ARQ information related to a downlink shared channel (DL-SCH); uplink scheduling grants containing at least modulation and coding format, resource allocation, and hybrid-ARQ information related to an uplink shared channel (UL-SCH). In addition to scheduling, PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB(s)) and orthogonal frequency division multiplexing (OFDM) symbol(s) where the UE may assume no transmission is intended for the UE; transmission of transmit power control (TPC) commands for physical uplink control channel (PUCCH) and PUSCH; transmission of one or more TPC commands for signaling route set (SRS) transmissions by one or more UEs; switching a UE's active bandwidth part; and initiating a random access procedure. A UE monitors a set of PDCCH candidates in the configured monitoring occasions in one or more configured control resource sets (CORESETs) according to the corresponding search space configurations. A CORESET consists of a set of PRBs with a time duration of 1 to 3 OFDM symbols. The resource units, resource element groups (REGs) and control channel elements (CCEs), are defined within a CORESET with each CCE consisting of a set of REGs. Control channels are formed by aggregation of CCEs. Different code rates for the control channels are realized by aggregating a different number of CCEs. Interleaved and non-interleaved CCE-to-REG mapping are supported in a CORESET. Polar coding is used for PDCCH. Each resource element group carrying PDCCH carries its own demodulation reference signal (DMRS). Quadrature phase shift keying (QPSK) modulation is used for PDCCH.

In fifth-generation wireless communication system, a list of search space configurations is signaled by the gNB for each configured BWP wherein each search space configuration is uniquely identified by an identifier (ID). The identifier of a search space configuration that is used for specific purposes such as paging reception, self-interference (SI) reception, and random access response reception, is explicitly signaled by gNB. In NR, search space configuration comprises parameters such as Monitoring-periodicity-PDCCH-slot, Monitoring-offset-PDCCH-slot, Monitoring-symbols-PDCCH-within-slot, and duration. A UE determines PDCCH monitoring occasion(s) within a slot using such parameters: the PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration where the slot with number ‘x’ in a radio frame with number ‘y’ satisfies the equation below:

(y*(number of slots in a radio frame)+x−Monitoring-offset-PDCCH-slot)mod(Monitoring-periodicity-PDCCH-slot)=0;

The starting symbol of a PDCCH monitoring occasion in each slot having a PDCCH monitoring occasion is given by Monitoring-symbols-PDCCH-within-slot. The length (in symbols) of a PDCCH monitoring occasion is given in the corset associated with the search space. Search space configuration includes the identifier of coreset configuration associated with it. A list of coreset configurations is signaled by the gNB for each configured BWP wherein each coreset configuration is uniquely identified by an identifier. Note that each radio frame is a 10 ms duration. The radio frame is identified by a radio frame number or system frame number. Each radio frame comprises several slots wherein the number of slots in the radio frame and the duration of the slots depends on subcarrier spacing (SCS). The number of slots in a radio frame and the duration of the slots for each supported SCS is pre-defined in NR. Each coreset configuration is associated with a list of transmission configuration indicator (TCI) states. One DL reference signal (RS) ID (single sideband (SSB) or channel state information reference signal (CSI RS)) is configured per TCI state. The list of TCI states corresponding to a coreset configuration is signalled by gNB via radio resource control (RRC) signaling. One of the TCI states in the TCI state list is activated and indicated to the UE by the gNB. The TCI state indicates the DL TX beam (DL TX beam is QCLed with SSB/CSI RS of TCI state) used by the gNB for transmission of the PDCCH in the PDCCH monitoring occasions of a search space.

In the fifth-generation wireless communication system, bandwidth adaptation (BA) is supported. With BA, the receive and transmit bandwidth of a UE need not be as large as the bandwidth of the cell and can be adjusted. For instance, the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a bandwidth part (BWP). BA is achieved by configuring RRC-connected UE with BWP(s) and telling the UE which of the configured BWPs is currently the active one. When BA is configured, the UE only has to monitor PDCCH on the one active BWP (i.e., it does not have to monitor PDCCH on the entire DL frequency of the serving cell). In an RRC-connected state, the UE is configured with one or more DL and UL BWPs, for each configured serving cell (i.e., PCell or SCell). For an activated serving cell, there is always one active UL and DL BWP at any point in time. The BWP switching for a serving cell is used to activate an inactive BWP and deactivate an active BWP at a particular time. The BWP switching is controlled by the PDCCH indicating a downlink assignment or an uplink grant, by the bwp-Inactivity Timer, by RRC signaling, or by the MAC entity itself upon initiation of random access procedure. Upon addition of SpCell or activation of an SCell, the DL BWP and UL BWP indicated by firstActiveDownlinkBWP-Id and firstActiveUplinkBWP-Id, respectively, is active without receiving a PDCCH indicating a downlink assignment or an uplink grant. The active BWP for a serving cell is indicated by either the RRC or PDCCH. For an unpaired spectrum, a DL BWP is paired with a UL BWP, and BWP switching is common for both UL and DL. Upon expiry of BWP inactivity timer, the UE may switch to the active DL BWP, to the default DL BWP, or to the initial DL BWP (if default DL BWP is not configured).

A 4G and 5G wireless communication system supports vehicular communication services. Vehicular communication services, represented by V2X services, can consist of the following four different types: V2V, V2I, V2N, and V2P. In a fifth-generation (also referred as NR or New Radio) wireless communication system, V2X communication is being enhanced to support enhanced V2X use cases, which are broadly arranged into four use case groups:
1) Vehicles Platooning enables the vehicles to dynamically form a platoon travelling together. All the vehicles in the platoon obtain information from the leading vehicle to manage this platoon. This information allows the vehicles to drive closer than normal in a coordinated manner, going in the same direction and travelling together.
2) Extended Sensors enables the exchange of raw or processed data gathered through local sensors or live video images among vehicles, road site units, devices of pedestrian, and V2X application servers. The vehicles can increase the perception of their environment beyond what their own sensors can detect and have a broader and holistic view of the local situation. High data rate is one of the key characteristics.
3) Advanced Driving enables semi-automated or full-automated driving. Each vehicle and/or road side unit (RSU) shares its own perception data obtained from its local sensors with vehicles in proximity and that allows vehicles to synchronize and coordinate their trajectories or maneuvers. Each vehicle shares its driving intention with vehicles in proximity too.
4) Remote Driving enables a remote driver or a V2X application to operate a remote vehicle for those passengers who cannot drive by themselves, or remote vehicles located in dangerous environments. For a case where variation is limited and routes are predictable, such as public transportation, driving based on cloud computing can be used. High reliability and low latency are the main requirements.

FIG. 1 illustrates an architecture of a sidelink communication system.

V2X services can be provided by PC5 interface and/or Uu interface. Support of V2X services via PC5 interface is provided by NR sidelink communication or V2X sidelink communication, which is a mode of communication whereby UEs can communicate with each other directly over the PC5 interface using NR technology or E-UTRA technology, respectively, without traversing any network node. This communication mode is supported when the UE is served by a radio access network (RAN) and when the UE is outside of the RAN coverage. Only the UEs authorized to be used for V2X services can perform NR or V2X sidelink communication. The next generation radio access network (NG-RAN) architecture supports the PC5 interface as illustrated in FIG. 1. Sidelink transmission and reception over the PC5 interface are supported when the UE is inside NG-RAN coverage, irrespective of which RRC state the UE is in, and when the UE is outside NG-RAN coverage. Support of V2X services via the PC5 interface can be provided by NR sidelink communication and/or V2X sidelink communication. NR sidelink communication may be used to support services other than V2X services.

NR or V2X sidelink communication can support three types of transmission modes. The first type may be unicast transmission, characterized by support of at least one PC5-RRC connection between peer UEs; transmission and reception of control information and user traffic between peer UEs in sidelink; support of sidelink hybrid automatic repeat request (HARQ) feedback; support of radio link control acknowledge mode (RLC AM); and support of sidelink radio link monitoring (RLM) for both peer UEs to detect radio link failure (RLF). The second type may be groupcast transmission, characterized by transmission and reception of user traffic among UEs belonging to a group in sidelink; and support of sidelink HARQ feedback. The third type may be broadcast transmission, characterized by transmission and reception of user traffic among UEs in sidelink.

The AS protocol stack for the control plane in the PC5 interface consists of RRC, packet data convergence protocol (PDCP), RLC and medium access control (MAC) sublayer, and the physical layer. The AS protocol stack for user plane in the PC5 interface consists of service data adaptation protocol (SDAP), PDCP, RLC and MAC sublayer, and the physical layer. Sidelink radio bearers (SLRB) are categorized into two groups: sidelink data radio bearers (SL DRB) for user plane data and sidelink signaling radio bearers (SL SRB) for control plane data. Separate SL SRBs using different sidelink control channels (SCCHs) are configured for PC5-RRC and PC5-S signaling respectively.

The MAC sublayer provides the following services and functions over the PC5 interface: radio resource selection; packet filtering; priority handling between uplink and sidelink transmissions for a given UE; and sidelink CSI reporting. With link control protocol (LCP) restrictions in MAC, only sidelink logical channels belonging to the same destination can be multiplexed into a MAC protocol data unit (PDU) for every unicast, groupcast, and broadcast transmission which is associated to the destination. NG-RAN can also control whether a sidelink logical channel can utilize the resources allocated to a configured sidelink grant Type 1. For packet filtering, a sidelink shared channel (SL-SCH) MAC header including portions of both Source Layer-2 ID and a Destination Layer-2 ID is added to each MAC PDU. Logical channel identifier (LCD) included within a MAC subheader uniquely identifies a logical channel within the scope of the Source Layer-2 ID and Destination Layer-2 ID combination. The following logical channels are used in sidelink:
Sidelink Control Channel (SCCH): a sidelink channel for transmitting control information from one UE to other UE(s);
Sidelink Traffic Channel (STCH): a sidelink channel for transmitting user information from one UE to other UE(s); and
Sidelink Broadcast Control Channel (SBCCH): a sidelink channel for broadcasting sidelink system information from one UE to other UE(s).

The following connections between logical channels and transport channels exist:
SCCH can be mapped to SL-SCH;
STCH can be mapped to SL-SCH; and
SBCCH can be mapped to sidelink broadcast channel (SL-BCH).

Sidelink operation involves the following physical layer channels and signals:
Physical Sidelink Control Channel (PSCCH) indicates resource and other transmission parameters used by a UE for PSSCH. PSCCH transmission is associated with a DM-RS.
Physical Sidelink Shared Channel (PSSCH) transmits the TBs of data themselves, and control information for HARQ procedures and CSI feedback triggers, etc. At least 6 OFDM symbols within a slot are used for PSSCH transmission. PSSCH transmission is associated with a DM-RS and may be associated with a phase tracking reference signal (PT-RS).
Physical Sidelink Feedback Channel (PSFCH) carries HARQ feedback over the sidelink from a UE which is an intended recipient of a PSSCH transmission to the UE which performed the transmission. PSFCH sequence is transmitted in one PRB repeated over two OFDM symbols near the end of the sidelink resource in a slot.
The Sidelink synchronization signal consists of sidelink primary and sidelink secondary synchronization signals (S-PSS, S-SSS), each occupying 2 symbols and 127 subcarriers. Physical Sidelink Broadcast Channel (PSBCH) occupies 9 and 5 symbols for normal and extended cyclic prefix (CP) cases respectively, including the associated DM-RS.
For unicast, channel state information reference signal (CSI-RS) is supported for CSI measurement and reporting in sidelink. A CSI report is carried in a sidelink MAC CE.

The RRC sublayer provides the following services and functions over the PC5 interface:
Transfer of a PC5-RRC message between peer UEs;
Maintenance and release of a PC5-RRC connection between two UEs; and
Detection of sidelink radio link failure for a PC5-RRC connection.

A PC5-RRC connection is a logical connection between two UEs for a pair of Source and Destination Layer-2 IDs which is considered to be established after a corresponding PC5 unicast link is established as specified in TS 23.287. There is one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages are used for a UE to transfer UE capability and sidelink configuration including SLRB configuration to the peer UE. Both peer UEs can exchange their own UE capability and sidelink configuration using separate bi-directional procedures in both sidelink directions. If it is not interested in sidelink transmission, if sidelink RLF on the PC5-RRC connection is declared, or if the Layer-2 link release procedure is completed as specified in TS 23.287, UE releases the PC5-RRC connection.

The UE can operate in two modes for resource allocation in sidelink:
Scheduled resource allocation, characterized by:
   The UE needs to be RRC CONNECTED in order to transmit data; and
   NG-RAN schedules transmission resources.
UE autonomous resource selection, characterized by:
   The UE can transmit data when inside NG-RAN coverage, irrespective of which RRC state the UE is in, and when outside NG-RAN coverage; and
   The UE autonomously selects transmission resources from a pool of resources.
For NR sidelink communication, the UE performs sidelink transmissions only on a single carrier.

Scheduled Resource Allocation:

NG-RAN can dynamically allocate resources to the UE via the sidelink radio network temporary identifier (SL-RNTI) on PDCCH(s) for NR sidelink communication. In addition, NG-RAN can allocate sidelink resources to UE with two types of configured sidelink grants:
With type 1, RRC directly provides the configured sidelink grant for NR sidelink communication.
With type 2, RRC provides the periodicity of the configured sidelink grant while PDCCH can either signal and activate the configured sidelink grant, or deactivate it. The PDCCH provides the actual grant (i.e., resources) to be used. The PDCCH is addressed to sidelink configured scheduling radio network temporary identifier (SL-CS-RNTI) for NR sidelink communication and SL semi-persistent scheduling vehicle radio network temporary identifier (V-RNTI) for V2X sidelink communication.

For the UE performing NR sidelink communication, there can be more than one configured sidelink grant activated at a time on the carrier configured for sidelink transmission. When beam failure or physical layer problem occurs on NR Uu, the UE can continue using the configured sidelink grant Type 1. During handover, the UE can be provided with configured sidelink grants via handover command, regardless of the type. If provided, the UE activates the configured sidelink grant Type 1 upon reception of the handover command. The UE can send sidelink buffer status report to support scheduler operation in NG-RAN. The sidelink buffer status reports refer to the data that is buffered for a group of logical channels (LCG) per destination in the UE. Eight LCGs are used for reporting of the sidelink buffer status reports. Two formats, which are sidelink buffer status report (SL BSR) and truncated SL BSR, are used.

UE Autonomous Resource Allocation:

The UE autonomously selects sidelink grant from a pool of resources provided by broadcast system information or dedicated signaling while inside NG-RAN coverage or by preconfiguration while outside NG-RAN coverage.

For NR sidelink communication, the pools of resources can be provided for a given validity area where the UE does not need to acquire a new pool of resources while moving within the validity area, at least when this pool is provided by system information block (SIB) (e.g., reuse valid area of NR SIB). The NR SIB validity mechanism is reused to enable validity area for SL resource pool configured via broadcasted system information. The UE is allowed to temporarily use UE autonomous resource selection with random selection for sidelink transmission based on configuration of the exceptional transmission resource pool.

For V2X sidelink transmission, during handover, transmission resource pool configurations including exceptional transmission resource pool for the target cell can be signaled in the handover command to reduce the transmission interruption. In this way, the UE may use the V2X sidelink transmission resource pools of the target cell before the handover is completed, as long as either synchronization is performed with the target cell in a case where the eNB is configured as the synchronization source, or synchronization is performed with global navigation satellite system (GNSS) in a case where the GNSS is configured as the synchronization source. If the exceptional transmission resource pool is included in the handover command, the UE uses randomly selected resources from the exceptional transmission resource pool, starting from the reception of handover command. If the UE is configured with scheduled resource allocation in the handover command, the UE continues to use the exceptional transmission resource pool while the timer associated with handover is running. If the UE is configured with autonomous resource selection in the target cell, the UE continues to use the exceptional transmission resource pool until the sensing results on the transmission resource pools for autonomous resource selection are available. For exceptional cases (e.g., during RLF, during transition from RRC IDLE to RRC CONNECTED, or during change of dedicated V2X sidelink resource pools within a cell), the UE may select resources in the exceptional pool provided in serving cell's SIB21 or in dedicated signaling based on random selection, and uses them temporarily. During cell reselection, the RRC IDLE UE may use the randomly selected resources from the exceptional transmission resource pool of the reselected cell until the sensing results on the transmission resource pools for autonomous resource selection are available.

The design of 5G wireless sidelink communication system needs to support operation on licensed as well as unlicensed carrier(s). Listen-before-talk (LBT) procedure is vital for fair and friendly coexistence of devices and technologies operating in an unlicensed spectrum. LBT procedures by a UE attempting to transmit on a sidelink carrier in an unlicensed spectrum require the UE to perform a clear channel assessment to determine if the channel is free for use. The various types or categories of LBT procedures used for sidelink transmission are as follows:

Type 1: LBT with random back-off with a contention window: A UE may transmit the transmission using Type 1 channel access procedure after first sensing the channel to be idle during the slot durations of a defer duration T_{d}, and after the counter N is zero in step 4 below. The counter N is adjusted by sensing the channel for additional slot duration(s) according to the steps described below.
1) set N=Nᵢₙᵢₜ, where Nᵢₙᵢₜ is a random number uniformly distributed between 0 and CWₚ, and go to step 4;
2) if N>0 and the UE chooses to decrement the counter, set N=N−1;
3) sense the channel for an additional slot duration, and if the additional slot duration is idle, go to step 4; else, go to step 5;
4) if N=0, stop; else, go to step 2;
5) sense the channel until either a busy slot is detected within an additional defer duration T_{d} or all the slots of the additional defer duration T_{d} are detected to be idle;
6) if the channel is sensed to be idle during all the slot durations of the additional defer duration T_{d}, go to step 4; else, go to step 5.

If a UE has not transmitted a UL transmission on a channel on which UL transmission(s) are performed after step 4 in the procedure above, the UE may transmit a transmission on the channel if the channel is sensed to be idle at least in a sensing slot duration Tₛₗ when the UE is ready to transmit the transmission and if the channel has been sensed to be idle during all the slot durations of a defer duration T_{d} immediately before the transmission. If the channel has not been sensed to be idle in a sensing slot duration Tₛₗ when the UE first senses the channel after it is ready to transmit, or if the channel has not been sensed to be idle during any of the sensing slot durations of a defer duration T_{d} immediately before the intended transmission, the UE proceeds to step 1 after sensing the channel to be idle during the slot durations of a defer duration T_{d}.

The defer duration T_{d} consists of duration T_{f}=16 us immediately followed by mₚ consecutive slot durations where each slot duration is Tₛₗ=9 us, and T_{f} includes an idle slot duration Tₛₗ at start of T_{f}.

CW_{min,p}≤CWₚ≤CW_{max,p} is the contention window. CW_{min,p} and CW_{max,p} are chosen before step 1 of the procedure above.

mₚ, CW_{min,p}, and CW_{max,p} are based on a channel access priority class p in Table 1 below.

TABLE 1

| Channel | | | | | |
|---|---|---|---|---|---|
| Access | | | | | |
| Priority | | | | | Allowed |
| Class (p) | mₚ | CW_{min,p} | CW_{max,p} | T_{mcot,p} | CWₚsizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63 } |
| 4 | 7 | 15 | 1023 | 8 or 10 ms | {15, 31, 63, 127, |
| | | | | | 255, 511, 1023} |

Type 2A: LBT without random back-off: The UE may transmit the transmission immediately after sensing the channel to be idle for at least a sensing interval T_{short_ul}=25 us. T_{short_ul} consists of a duration T_{f}=16 us immediately followed by one sensing slot and T_{f} includes a sensing slot at start of T_{f}. The channel is considered to be idle for T_{short_ul} if both sensing slots of T_{short_ul} are sensed to be idle.

Type 2B: The UE may transmit the transmission immediately after sensing the channel to be idle within a duration of T_{f}=16 us. T_{f} includes a sensing slot that occurs within the last 9 us of T_{f}. The channel is considered to be idle within the duration T_{f} if the channel is sensed to be idle for a total of at least 5 us with at least 4 us of sensing occurring in the sensing slot.

Type 2C: No LBT: The UE does not sense the channel before the transmission. The duration of the corresponding UL transmission is at most 584 us.

The issue is that in a case where the UE is not able to transmit due to LBT on several occasions, sidelink communication or discovery can be interrupted. A method is needed to recover from such failures. Note that sidelink communication or discovery can be for various use cases such as for public safety, V2X, etc.

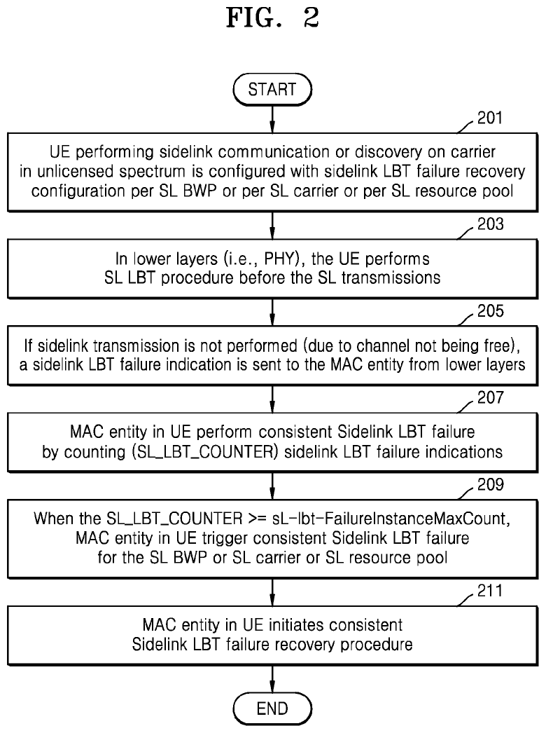

FIG. 2 illustrates a flow chart describing a method performed by a user equipment (UE) according to an embodiment of the disclosure.

In step 201, the UE performing sidelink communication or discovery on a carrier in an unlicensed spectrum can be configured with sidelink LBT failure recovery configuration. This configuration includes sL-lbt-FailureInstanceMaxCount for the consistent sidelink LBT failure detection and sL-lbt-FailureDetectionTimer for the consistent sidelink LBT failure detection. Sidelink LBT failure recovery configuration can be configured per SL BWP, or per SL carrier, or per SL resource pool, which can also be referred as a set of sidelink resources or a set of sidelink resource blocks. Note that the UE can be configured with one or more carriers for sidelink communication. Sidelink LBT failure recovery configuration can be signaled via a RRCReconfiguration message, or a system information block (SIB), or in an SL pre-configuration, or in an RRC message, or in any other signaling sent by a peer UE. Note that sidelink LBT failure configuration signaling by the gNB to the UE for sidelink communication is different from the LBT failure configuration signaled by the gNB to the UE for uplink communication towards the gNB.

In step 203, in lower layers (i.e., the PHY layer), the UE performs SL LBT procedure before the SL transmissions on a carrier used for sidelink communication or discovery if the carrier is an unlicensed carrier.

In step 205, if sidelink LBT failure recovery configuration is configured for the carrier, or for the SL BWP of the carrier, or for the SL resource pool/resource set/resource block set used for transmission, when the lower layer performs an LBT procedure before sidelink transmission and the sidelink transmission is not performed (due to channel not being free), a sidelink LBT failure indication is sent to the MAC entity from lower layers. Note that this indication is different from the indication sent to the MAC layer when uplink LBT failure is detected by the UE for uplink transmissions to the gNB. The lower layer indicates whether the LBT failure indication is for uplink or sidelink. The MAC entity applies a different procedure for consistent LBT failure detection and recovery procedure for sidelink and uplink (such as different LBT counter, different counter max values, different values of detection timer, different indication from lower layer, different actions upon consistent failure detection, etc.).

In step 207, the MAC entity in the UE may be configured with a consistent sidelink LBT failure recovery procedure. The MAC entity performs consistent sidelink LBT failure recovery procedure if the sidelink LBT failure recovery configuration is configured. Consistent sidelink LBT failure is detected per SL BWP, or per SL carrier, or per SL resource pool/resource set/resource block set by counting sidelink LBT failure indications received from the lower layer.

In an embodiment, a single counter is maintained per SL carrier, or per SL BWP, or per SL resource pool/resource set/resource block set, and counting is performed for all SL transmissions, which means that the lower layer sends the sidelink LBT failure indication irrespective of the type of transmissions (PSSCH or PSCCH or PSFCH or PSBCH or S-PSS or S-SSS) for which the LBT failure is detected.

In an embodiment, a single counter is maintained per SL carrier, or per SL BWP, or per SL resource pool/resource set/resource block set, and counting is performed for SL transmissions related to PSSCH, which means that the lower layer sends the sidelink LBT failure indication when LBT failure is detected for transmissions related to PSSCH. For SL transmissions on other SL channels, LBT failure indication is not sent by the lower layer to the MAC entity.

In an embodiment, a single counter is maintained per SL carrier, or per SL BWP, or per SL resource pool/resource set/resource block set, and counting is performed for SL transmissions related to PSSCH and PSCCH, which means that the lower layer sends the sidelink LBT failure indication when LBT failure is detected for transmissions related to PSSCH and PSCCH. For SL transmissions on other SL channels, LBT failure indication is not sent by the lower layer to the MAC entity.

In an embodiment, a single counter is maintained per SL carrier, or SL BWP, or SL resource pool/resource set/resource block set, and counting is performed for SL transmissions related to PSSCH, PSCCH and PSFCH, which means that lower layer sends the sidelink LBT failure indication when LBT failure is detected for transmissions related to PSSCH, PSCCH and PSFCH. For SL transmissions on other SL channels, LBT failure indication is not sent by the lower layer to the MAC entity.

In an embodiment, consistent sidelink LBT failure may be detected only for the transmissions performed using scheduled resource allocation (or mode 1).

In step 209, the MAC entity in the UE may trigger consistent sidelink LBT failure for the SL BWP, or SL carrier, or SL resource pool/resource set/resource block set when the counter (SL_LBT_COUNTER) is greater than or equal to sL-lbt-FailureInstanceMaxCount.

In step 211, the MAC entity in the UE may initiate consistent sidelink LBT failure recovery procedure.

Consistent Sidelink LBT Failure Detection:

For an SL carrier, or SL BWP, or SL resource pool/resource set/resource block set configured with sidelink LBT failure recovery configuration, the MAC entity in UE shall:
1> if sidelink LBT failure indication has been received from lower layers:
   2> start or restart the sL-lbt-FailureDetectionTimer;
   2> increment SL_LBT_COUNTER by 1;
   2> if SL_LBT_COUNTER>=sL-lbt-FailureInstanceMaxCount:
      3> trigger consistent sidelink LBT failure for the SL BWP, or SL carrier, or SL resource pool/resource set/resource block set.

Note that the SL_LBT_COUNTER is maintained per carrier, or per SL BWP, or per SL resource pool/resource set/resource block set. In an embodiment, consistent sidelink LBT failure for the SL BWP, or SL carrier, or SL resource pool/resource set/resource block set can be detected separately for each channel (PSSCH or PSCCH or PSFCH or PSBCH or S-PSS or S-SSS) and in this case SL_LBT_COUNTER and sL-lbt-FailureDetectionTimer are maintained separately for each channel and LBT failure indication is sent by lower layers separately for each channel. In an embodiment, consistent sidelink LBT failure for the SL BWP, or SL carrier, or SL resource pool/resource set/resource block set can be detected separately for a 1^{st} group of channels consisting of PSSCH/PSCCH/PSFCH and a 2^{nd} group of channels consisting of PSBCH/S-PS S/S-SSS, and in this case SL_LBT_COUNTER and sL-lbt-FailureDetectionTimer are maintained separately for the 1^{st} group and the 2^{nd} group of channels and the LBT failure indication is sent by the lower layers separately for each group.

Resetting SL_LBT_COUNTER:
1> if all triggered consistent SL LBT failures are cancelled; or
1> if the sL-lbt-FailureDetectionTimer expires; or
1> if sL-lbt-FailureDetectionTimer or sL-lbt-FailureInstanceMaxCount is reconfigured by upper layers:
   2> set SL_LBT_COUNTER to 0.

Upon consistent sidelink LBT failure detection on the SL BWP, or SL carrier, or SL resource pool/resource set/resource block set, the UE may perform the operation as follows:
Option 1: The UE may transmit an RRC message to the gNB indicating consistent sidelink LBT failure. The UE may additionally indicate to the gNB information about SL carrier(s) and/or SL BWP ID (s) and/or SL resource pool/resource set/resource block set index(s) on which consistent sidelink LBT failure is detected. In an embodiment, the UE may perform this operation when the UE is in RRC CONNECTED state. In an embodiment, the UE may send an RRC message indicating consistent sidelink LBT failure in Msg3 or MsgA using random access procedure when the UE is in RRC IDLE or RRC INACTIVE state.
Option 2: The UE may transmit SL LBT failure MAC CE to the gNB. In the MAC CE, the UE may indicate SL carrier(s) and/or SL BWP ID(s) and/or SL resource pool/resource set/resource block set index(s) of resource pool/resource set/resource block set on which consistent sidelink LBT failure is detected. In an embodiment, the UE may perform this operation when the UE is in RRC CONNECTED state.

A scheduling request may be supported for reporting consistent sidelink LBT failure detection to the gNB. Scheduling request resources for SL LBT failure can be indicated via RRCReconfiguration message. If UL-SCH resources are available for a new transmission and these UL-SCH resources can accommodate the SL LBT failure MAC CE plus its subheader, as a result of logical channel prioritization, the MAC entity may instruct the multiplexing and assembly procedure to generate the SL LBT failure MAC CE. Otherwise, the MAC entity may trigger a scheduling request for SL LBT failure MAC CE.

In response to SL LBT failure indication as per option 1 and option 2, the network can configure/change the SL BWP, or SL carrier, or SL resource pool/resource set/resource block set.

In an embodiment, in option 1 and option 2, the UE may be configured with a fall back carrier (e.g., on a licensed spectrum or unlicensed spectrum) for sidelink communication. The UE may switch to this carrier upon detection of consistent sidelink LBT failure in an unlicensed sidelink carrier. Fall back carrier and sidelink configuration on this carrier may be signaled via RRCReconfiguration message, or system information block (SIB), or in SL pre configuration, or in RRC message, or in any other signaling sent by a peer UE. In an embodiment, switching may be performed upon receiving indication from the gNB in response to consistent sidelink LBT failure sent by the UE.

In an embodiment, option 1 and option 2 may only be applied for the consistent sidelink LBT failure detected for the transmissions performed using scheduled resource allocation (or mode 1). In other words, option 1 and option 2 may be applied if the UE is using scheduled resource allocation (or mode 1) for sidelink communication (on SL BWP, or SL carrier, or SL resource pool/resource set/resource block set for which consistent sidelink LBT failure is detected).
Option 3: The UE deactivates the SL BWP, or SL carrier, or SL resource pool/resource set/resource block set for a specified time duration (a timer can be started upon detection of consistent sidelink LBT failure; the UE does not use SL BWP, or SL carrier, or SL resource pool/resource set/resource block set where a consistent sidelink LBT failure was detected and upon expiry of the timer, the UE can again start to use SL BWP, or SL carrier, or SL resource pool/resource set/resource block set where consistent sidelink LBT failure was detected). Timer duration can be signaled by the gNB in the SIB, or RRC message, or SL pre configuration. In an embodiment, the UE may be configured with a fall back carrier (e.g., on a licensed spectrum or unlicensed spectrum), or fall back SL BWP, or fall back SL resource pool/resource set/resource block set for sidelink communication. The UE may switch to this upon detection of consistent sidelink LBT failure in an unlicensed sidelink carrier and use it for sidelink communication while the timer is running.
Option 4: UE may declare SL RLF and the SL RLF procedure is initiated. SL RLF is declared for all destinations with which the UE was communicating using the carrier, or SL BWP, or SL resource pool/resource set/resource block set for which consistent sidelink LBT failure is detected. The UE may release the DRBs, SRBs, PC5 Relay RLC channels, of these destinations; discard the NR sidelink communication related configuration of these destinations; reset the sidelink specific MAC of these destinations; consider the PC5-RRC connection is released for these destinations; and indicate the release of the PC5-RRC connection to the upper layers for these destinations (i.e., PC5 is unavailable).
Option 5: The UE may send an RRC message to a peer UE indicating consistent sidelink LBT failure. The UE may additionally indicate to the peer UE information about the SL carrier(s) and/or SL BWP ID(s) and/or SL resource pool/resource set/resource block set index(s) on which consistent sidelink LBT failure is detected.
Option 6: The UE may send SL LBT failure MAC CE to a peer UE. In the MAC CE, the UE may indicate the SL carrier(s) and/or SL BWP ID(s) and/or SL resource pool/resource set/resource block set index(s) of resource pool/resource set/resource block set on which consistent sidelink LBT failure is detected.
Option 7: If the consistent sidelink LBT failure is detected for a resource pool/resource set/resource block set, the UE may stop using the resource pool/resource set/resource block set for a timer duration as in option 3 above. The UE may then start using the other SL resource pool/resource set/resource block set for which consistent LBT failure is not detected. If sidelink LBT failure is detected for all SL resource pools/resource sets/resource block sets of a SL BWP of SL carrier, the UE may then inform the gNB as in option 1 and option 2. If sidelink LBT failure is detected for all SL resource pools/resource sets/resource block sets of a SL BWP of SL carrier, the UE can switch to another SL BWP (if available) for which consistent LBT failure is not detected. If another SL BWP is not available or consistent LBT failure is detected for all configured SL BWPs, the UE may switch to another carrier or the UE may inform the gNB as in option 1 and option 2.
Option 8: If the consistent sidelink LBT failure is detected for a SL BWP and multiple SL BWPs are configured for a SL carrier, the UE may switch to another SL BWP for which consistent LBT failure is not detected. If sidelink LBT failure is detected for all SL BWPs of a SL carrier, the UE may switch to another SL carrier or the UE may inform the gNB as in option 1 and option 2.
Option 9: The UE may release the SL connection.
Option 10: The UE in a RRC IDLE and RRC INACTIVE state may trigger cell reselection.

In option 2 above, the MAC entity may perform cancellation of triggered consistent SL LBT failure(s) as follows:
1> if a MAC PDU is transmitted and LBT failure indication is not received from lower layers and this PDU includes the SL LBT failure MAC CE:
   2> cancel all the triggered consistent SL LBT failure(s) for which consistent SL LBT failure was indicated in the transmitted SL LBT failure MAC CE.
1> if sL-lbt-FailureRecoveryConfig is reconfigured by upper layers for a SL BWP or SL carrier:
   2> cancel all the triggered consistent SL LBT failure(s) for the SL BWP or SL carrier.

In option 2 above, the MAC entity may perform RA cancellation based on SL LBT failure as follows: the MAC entity may stop, if any, ongoing random access procedure due to a pending SR for consistent sidelink LBT failure recovery, which has no valid PUCCH resources configured, if:

a MAC PDU is transmitted using a UL grant other than a UL grant provided by random access response or a UL grant determined as specified in 3 GPP, clause 5.1.2a for the transmission of the MSGA payload. This PDU includes an SL LBT failure MAC CE that indicates consistent SL LBT failure for SL BWP or carrier triggered consistent SL LBT failure.

In the option 2 above, the MAC entity may perform SR cancellation based on SL LBT failure as follows:
1> if this SR was triggered by consistent SL LBT failure recovery and a MAC PDU is transmitted and the MAC PDU includes an SL LBT failure MAC CE that indicates consistent SL LBT failure for SL BWP or SL carrier; or
1> if this SR was triggered by consistent SL LBT failure recovery and all the triggered consistent SL LBT failure(s) are cancelled:
   2> cancel the pending SR and stop the corresponding sr-ProhibitTimer, if running.

In an embodiment, the MAC entity in the UE stop sl-lbt-FailureDetectionTimer and set SL_LBT_COUNTER to 0 when the MAC is reset.

In the option 2 above, MAC CE for SL LBT failure is reported to the gNB and while generating the MAC PDU to be transmitted to the gNB in UL grant, selection of Logical channels to be included in MAC PDU shall be prioritized in accordance with the following order (highest priority listed first):
MAC CE for C-RNTI, or data from UL-CCCH;
MAC CE for (Enhanced) BFR, or MAC CE for Configured Grant Confirmation, or MAC CE for Multiple Entry Configured Grant Confirmation;
MAC CE for Sidelink Configured Grant Confirmation;
MAC CE for LBT failure;
MAC CE for SL LBT failure;
MAC CE for Timing Advance Report;
MAC CE for SL-BSR prioritized according to clause 5.22.1.6 of 3GPP;
MAC CE for (Extended) BSR, with exception of BSR included for padding;
MAC CE for (Enhanced) Single Entry PHR, or MAC CE for (Enhanced) Multiple Entry PHR;
MAC CE for Positioning Measurement Gap Activation/Deactivation Request;
MAC CE for the number of Desired Guard Symbols;
MAC CE for Case-6 Timing Request;
MAC CE for (Extended) Pre-emptive BSR;
MAC CE for SL-BSR, with exception of SL-BSR prioritized according to clause 5.22.1.6 of 3GPP and SL-BSR included for padding;
MAC CE for IAB-MT Recommended Beam Indication, or MAC CE for Desired IAB-MT PSD range, or MAC CE for Desired DL Tx Power Adjustment;
data from any Logical Channel, except data from UL-CCCH;
MAC CE for Recommended bit rate query;
MAC CE for BSR included for padding; and
MAC CE for SL-BSR included for padding.

In accordance with an embodiment of the present disclosure, a method performed by a user equipment (UE) in a wireless communication system is provided. The method may comprise: receiving, from a base station, configuration information associated with a sidelink (SL) listen-before-talk (LBT) failure recovery; identifying a counter value associated with an SL LBT failure detection, based on an SL LBT failure indication received from a lower layer; and in a case where the counter value is greater than or equal to a threshold value, triggering an SL consistent LBT failure.

In further embodiments, the counter value is incremented by one in a case where the SL LBT failure indication is received and the method may further comprise: transmitting, to the base station, an SL LBT failure medium access control (MAC) control element (CE) for the triggered SL consistent LBT failure.

In further embodiments, the configuration information includes information associated with the threshold value and information associated with a timer related to the above SL LBT failure detection, and the method may further comprise: in a case where the SL LBT failure indication is received, starting or restarting the timer.

In further embodiments, the counter value is reset to zero in a case where the timer expires or in a case where information associated with the threshold value or information associated with the timer is reconfigured.

In further embodiments, the configuration information is received via a radio resource control (RRC) reconfiguration message, or system information, or SL pre-configuration information, and the configuration information is configured per an SL bandwidth part (BWP).

In further embodiments, the SL LBT failure indication is triggered in a case where the UE fails to access a channel prior to an SL transmission.

In further embodiments, the identifying of the counter value comprises: counting the SL LBT failure indication for all SL transmissions.

In further embodiments, the method may further comprise: if uplink-shared channel (UL-SCH) resources are available for a new transmission and the UL-SCH resources can accommodate an SL LBT failure medium access control (MAC) control element (CE) and a subheader of the SL LBT failure MAC CE: generating the SL LBT failure MAC CE indicating resource related information for the SL consistent LBT failure; and else: triggering a scheduling request for the SL LBT failure MAC CE.

In further embodiments, the method may further comprise: selecting a logical channel, based on priorities of logical channels, wherein the SL LBT failure MAC CE has a higher priority than at least one MAC CE including an MAC CE for a timing advance report, and wherein the SL LBT failure MAC CE has a lower priority than at least one MAC CE including an MAC CE for a sidelink configured grant confirmation or an MAC CE for a beam failure report (BER).

In further embodiments, the method may further comprise: in a case where a MAC protocol data unit (PDU) is transmitted and the MAC PDU includes the SL LBT failure MAC CE or the triggered SL consistent LBT failure is cancelled, cancelling the scheduling request and stopping a timer associated with the scheduling request.

In further embodiments, the method may further comprise: in a case where a MAC PDU is transmitted and the MAC PDU includes the SL LBT failure MAC CE, cancelling the triggered SL consistent LBT failure.

In further embodiments, the method may further comprise: in a case where the configuration information associated with the SL LBT failure recovery is reconfigured, cancelling the triggered SL consistent LBT failure.

In further embodiments, the method may further comprise: receiving, from the base station, scheduling request configuration information associated with an SL consistent LBT failure report; and transmitting, to the base station, a scheduling request for the SL consistent LBT failure report, based on the scheduling request configuration information.

In further embodiments, the method may further comprise: based on the triggering of the SL consistent LBT failure, declaring a radio link failure (RLF) and performing a radio link failure (RLF) related operation for one or more destinations, and wherein the performing of the RLF related operation comprises: releasing a data radio bearers (DRBs), signaling radio bearers (SRBs) and PC5 relay radio link control (RLC) channels of the destinations; discarding a new radio (NR) SL communication related configuration of the destinations; resetting an SL specific MAC of the destinations; and transmitting, to upper layers, indication of a release of a PC5-RRC connection for the destinations.

In accordance with an embodiment of the present disclosure, a user equipment (UE) in a wireless communication system is provided. The UE may comprise: a transceiver; and at least one processor coupled to the transceiver and configured to: receive, from a base station via the transceiver, configuration information associated with a sidelink (SL) listen-before-talk (LBT) failure recovery; identify a counter value associated with an SL LBT failure detection, based on an SL failure indication received from a lower layer; and in a case where the counter value is greater than or equal to a threshold value, trigger an SL consistent LBT failure.

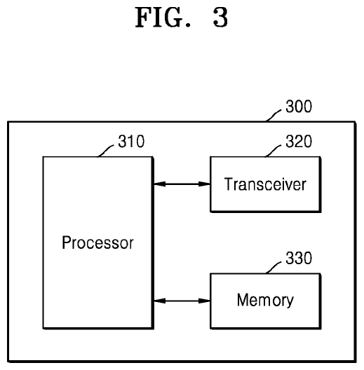

FIG. 3 is a diagram illustrating a UE 300 according to an embodiment of the present disclosure.

Referring to the FIG. 3, the UE 300 may include a processor 310, a transceiver 320, and a memory 330. However, all of the illustrated components are not essential. The UE 300 may be implemented by more or less components than those illustrated in the FIG. 3. In addition, the processor 310, and the transceiver 320, and the memory 330 may be implemented as a single chip according to another embodiment.

The aforementioned components will now be described in detail.

The processor 310 may include one or more processors or other processing devices that control the proposed function, process, and/or method. Operation of the UE 300 may be implemented by the processor 310.

The transceiver 320 may be connected to the processor 310 and transmit and/or receive a signal. In addition, the transceiver 320 may receive the signal through a wireless channel and output the signal to the processor 310. The transceiver 320 may transmit the signal output from the processor 310 through the wireless channel.

The memory 330 may store the control information or the data included in a signal obtained by the UE 300. The memory 330 may be connected to the processor 310 and store at least one instruction, or a protocol, or a parameter for the proposed function, process, and/or method. The memory 330 may include read-only memory (ROM) and/or random access memory (RAM) and/or hard disk and/or CD-ROM and/or DVD and/or other storage devices.

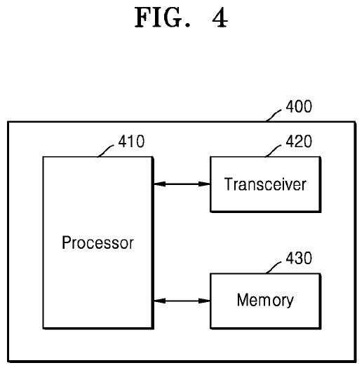

FIG. 4 is a diagram illustrating a base station 400 according to an embodiment of the present disclosure.

Referring to the FIG. 4, the base station 400 may include a processor 410, a transceiver 420 and a memory 430. However, all of the illustrated components are not essential. The base station 400 may be implemented by more or less components than those illustrated in FIG. 4. In addition, the processor 410, and the transceiver 420, and the memory 430 may be implemented as a single chip according to another embodiment. The aforementioned components will now be described in detail.

The processor 410 may include one or more processors or other processing devices that control the proposed function, process, and/or method. Operation of the base station 400 may be implemented by the processor 410.

The transceiver 420 may be connected to the processor 410 and transmit and/or receive a signal. The signal may include control information and data. In addition, the transceiver 420 may receive the signal through a wireless channel and output the signal to the processor 410. The transceiver 420 may transmit a signal output from the processor 410 through the wireless channel.

The memory 430 may store the control information or the data included in a signal obtained by the base station 400. The memory 430 may be connected to the processor 410 and store at least one instruction or a protocol or a parameter for the proposed function, process, and/or method. The memory 430 may include read-only memory (ROM) and/or random access memory (RAM) and/or hard disk and/or CD-ROM and/or DVD and/or other storage devices.

Methods according to the claims of the disclosure or the various embodiments of the disclosure described in the specification may be implemented in hardware, software, or a combination of hardware and software.

When implemented in software, a computer-readable storage medium storing one or more programs (software modules) may be provided. One or more programs stored in the computer-readable storage medium are configured for execution by one or more processors in an electronic device. The one or more programs may include instructions that cause the electronic device to perform the methods in accordance with the claims of the disclosure or the various embodiments of the disclosure described in the specification.

The programs (software modules, software) may be stored in a random access memory (RAM), a non-volatile memory including a flash memory, a read only memory (ROM), an electrically erasable programmable ROM (EEPROM), a magnetic disc storage device, a compact disc-ROM (CD-ROM), a digital versatile disc (DVD) or other types of optical storage device, and/or a magnetic cassette. Alternatively, the programs may be stored in a memory including a combination of some or all of them. There may be a plurality of memories.

The program may also be stored in an attachable storage device that may be accessed over a communication network including the Internet, an intranet, a Local Area Network (LAN), a wide area network (WAN), or a storage area network (SAN), or a combination thereof. The storage device may be connected to an apparatus performing the various embodiments of the disclosure through an external port. In addition, a separate storage device in the communication network may be connected to the apparatus performing the various embodiments of the disclosure.

In the various embodiments of the present disclosure, a component is represented in a singular or plural form. It should be understood, however, that the singular or plural representations are selected appropriately according to the situations presented for convenience of explanation, and the disclosure is not limited to the singular or plural form of the component. Further, the component expressed in the plural form may also imply the singular form, and vice versa.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, configuration information associated with a sidelink (SL) listen-before-talk (LBT) failure recovery;
identifying a counter value associated with an SL LBT failure detection, based on an SL LBT failure indication received from a lower layer; and
in case that the counter value is greater than or equal to a threshold value, triggering an SL consistent LBT failure.

2. The method of claim 1, wherein the counter value is incremented by one in case that the SL LBT failure indication is received, and
wherein the method further comprises:
transmitting, to the base station, an SL LBT failure medium access control (MAC) control element (CE) for the triggered SL consistent LBT failure.

3. The method of claim 1, wherein the configuration information includes information associated with the threshold value and information associated with a timer related to the SL LBT failure detection, and
wherein the method further comprises:
in case that the SL LBT failure indication is received, starting or restarting the timer.

4. The method of claim 3, wherein the counter value is reset to zero in case that the timer expires or in case that the information associated with the threshold value or the information associated with the timer is reconfigured.

5. The method of claim 1, wherein the configuration information is received via a radio resource control (RRC) reconfiguration message, or system information, or SL pre-configuration information, and
wherein the configuration information is configured per an SL bandwidth part (BWP).

6. The method of claim 1, wherein the SL LBT failure indication is triggered in case that the UE fails to access a channel prior to an SL transmission.

7. The method of claim 1, wherein the identifying of the counter value comprises:
counting the SL LBT failure indication for all SL transmissions.

8. The method of claim 1, further comprising:
if uplink-shared channel (UL-SCH) resources are available for a new transmission and the UL-SCH resources can accommodate an SL LBT failure MAC CE and a subheader of the SL LBT failure MAC CE:
generating the SL LBT failure MAC CE indicating resource related information for the SL consistent LBT failure; and
else:
triggering a scheduling request for the SL LBT failure MAC CE.

9. The method of claim 8, further comprising:
selecting a logical channel, based on priorities of logical channels, wherein the SL LBT failure MAC CE has a higher priority than at least one MAC CE including an MAC CE for a timing advance report, and
wherein the SL LBT failure MAC CE has a lower priority than at least one MAC CE including an MAC CE for a sidelink configured grant confirmation or an MAC CE for a beam failure report (BFR).

10. The method of claim 8, further comprising:
in case that a MAC protocol data unit (PDU) is transmitted and the MAC PDU includes the SL LBT failure MAC CE or the triggered SL consistent LBT failure is cancelled, cancelling the scheduling request and stopping a timer associated with the scheduling request.

11. The method of claim 8, further comprising:
in case that a MAC PDU is transmitted and the MAC PDU includes the SL LBT failure MAC CE, cancelling the triggered SL consistent LBT failure.

12. The method of claim 1, further comprising:
in case that the configuration information associated with the SL LBT failure recovery is reconfigured, cancelling the triggered SL consistent LBT failure.

13. The method of claim 1, further comprising:
receiving, from the base station, scheduling request configuration information associated with an SL consistent LBT failure report; and
transmitting, to the base station, a scheduling request for the SL consistent LBT failure report, based on the scheduling request configuration information.

14. The method of claim 1, further comprising:
based on the triggering of the SL consistent LBT failure, declaring a radio link failure (RLF) and performing an RLF related operation for one or more destinations, and
wherein the performing of the RLF related operation comprises:
releasing a data radio bearers (DRBs), signaling radio bearers (SRBs) and PC5 relay radio link control (RLC) channels of the one or more destinations;
discarding a new radio (NR) SL communication related configuration of the one or more destinations;
resetting an SL specific MAC of the one or more destinations; and
transmitting, to upper layers, indication of a release of a PC5-RRC connection for the one or more destinations.

15. A user equipment (UE) in a wireless communication system, the UE comprising:
a transceiver; and
at least one processor coupled to the transceiver and configured to:
receive, from a base station via the transceiver, configuration information associated with a sidelink (SL) listen-before-talk (LBT) failure recovery;
identify a counter value associated with an SL LBT failure detection, based on an SL failure indication received from a lower layer; and
in case that the counter value is greater than or equal to a threshold value, trigger an SL consistent LBT failure.
